(19) United States
(12) Patent Application Publication
(10) Pub. No.: US 2026/0080490 A1
(43) Pub. Date: Mar. 19, 2026

(54) Universal Educational Dashboard for Monitoring Student AI Usage and Learning Engagement Analysis

(71) Applicant: Krystle Marie Wright, Rainier, OR (US)

(72) Inventor: Krystle Marie Wright, Rainier, OR (US)

(21) Appl. No.: 18/887,012

(22) Filed: Sep. 16, 2024

(51) Int. Cl. G06Q 50/20

(52) U.S. Cl. CPC G06Q 50/205

(57) ABSTRACT

The invention provides a comprehensive system for monitoring and analyzing student engagement with AI tools across various educational platforms. It includes a Teacher Dashboard for real-time analytics on student interactions with AI tools. The system tracks human prompts, text edits, and interaction frequency, generating personalized feedback to ensure genuine learning. Teachers can manage large student enrollments, contact colleagues within the system, and utilize a Grading Assistance Tool that suggests grades based on an algorithm analyzing AI engagement and learning outcomes.

### BACKGROUND OF THE INVENTION

The increase in AI tools in education necessitates a robust system for monitoring student engagement and ensuring genuine learning outcomes. Current solutions lack comprehensive capabilities for real-time analytics, personalized feedback, internal communication, and grading assistance based on AI interactions. This invention addresses these gaps by offering a unified platform for analyzing AI engagement, facilitating teacher collaboration, and assisting with grading across various educational contexts.

### SUMMARY OF THE INVENTION

The invention is a system for monitoring and analyzing student engagement with AI tools, integrated within a versatile educational platform. It includes a Teacher Dashboard for real-time analytics, allowing teachers to manage large enrollments, communicate internally, and utilize a Grading Assistance Tool. The tool suggests grades based on an algorithm analyzing AI interaction data, ensuring the platform's use leads to meaningful learning experiences.

### BRIEF DESCRIPTION OF DRAWINGS

FIG. 1: System Architecture

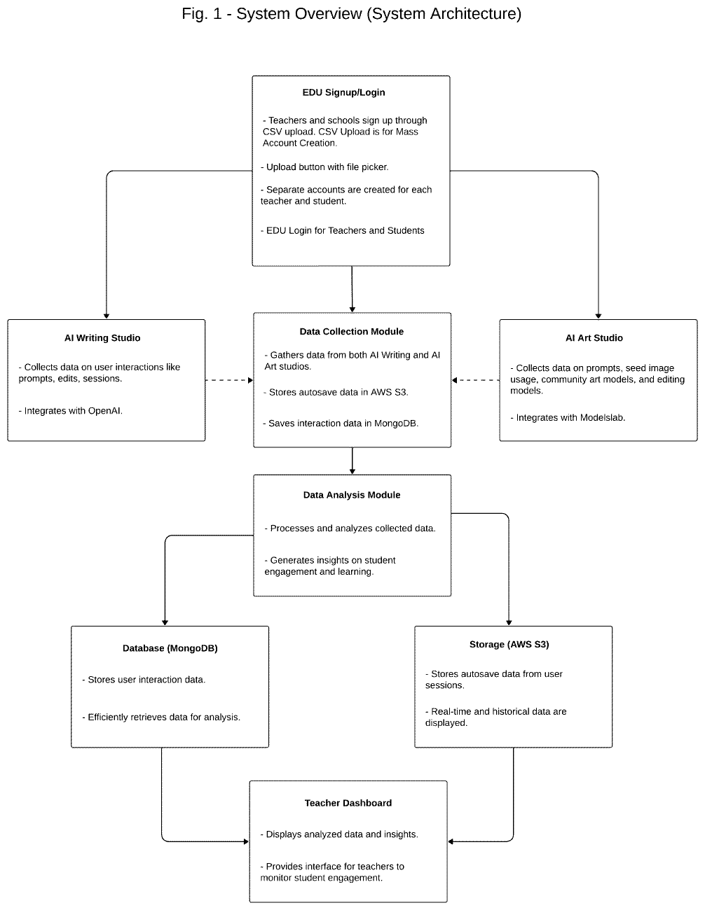

This figure presents the overall system architecture, including the AI Writing Studio and AI Art Studio for data collection. The collected data is managed by the Data Collection Module and analyzed by the Data Analysis Module, with storage in MongoDB and AWS S3, and insights displayed on the Teacher Dashboard.

FIG. 2: Data Flow in AI Writing Studio

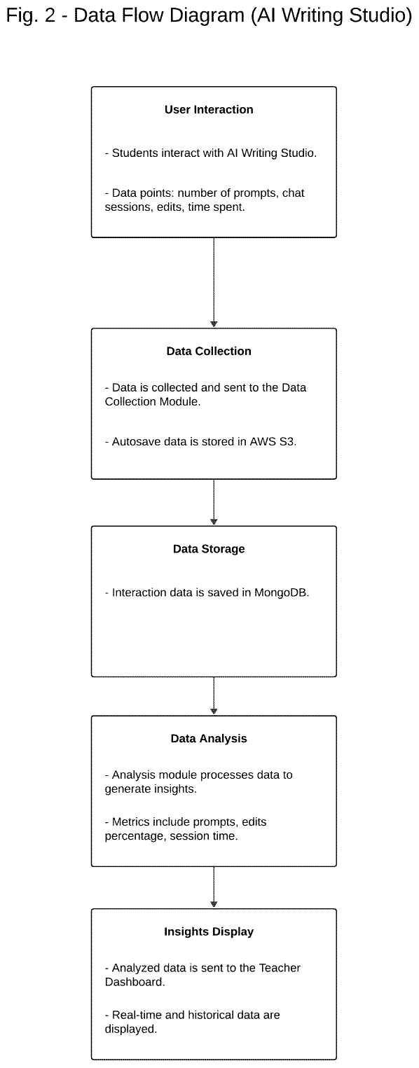

The figure shows the data flow in the AI Writing Studio, where student interactions generate data points that are collected and stored in MongoDB and AWS S3. The Data Analysis Module processes this data to produce insights displayed on the Teacher Dashboard.

FIG. 3: Data Flow in AI Art Studio

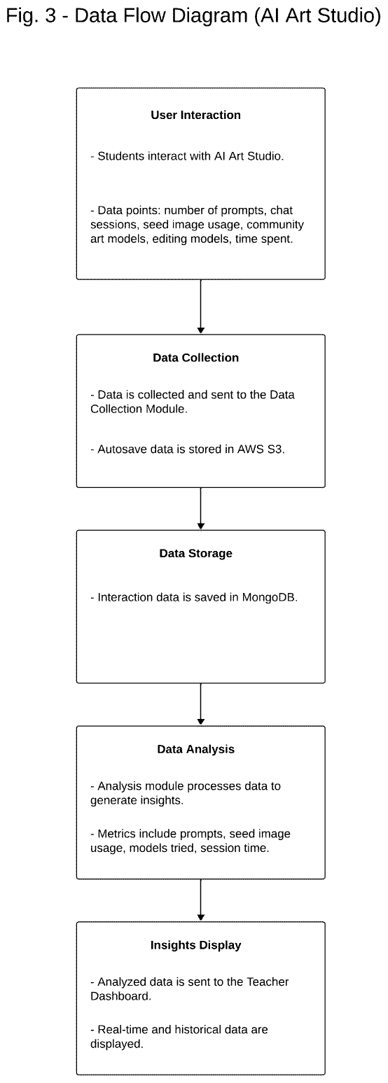

This figure illustrates the data flow in the AI Art Studio, detailing how student interactions generate data that is collected and stored in MongoDB. The Data Analysis Module processes this data to create insights for display on the Teacher Dashboard.

FIG. 4: Component Interaction for AI Writing Analysis

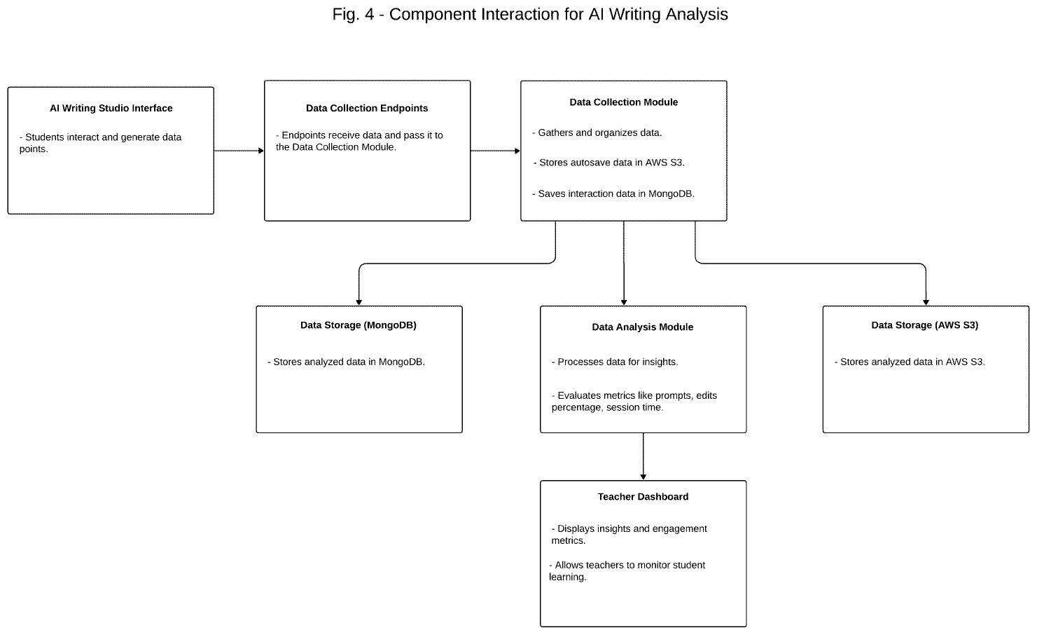

This figure outlines the component interactions for AI Writing Analysis, showing how student data is collected, stored in MongoDB and AWS S3, and processed by the Data Analysis Module. Insights are then displayed on the Teacher Dashboard.

FIG. 5: Component Interaction for AI Art Analysis

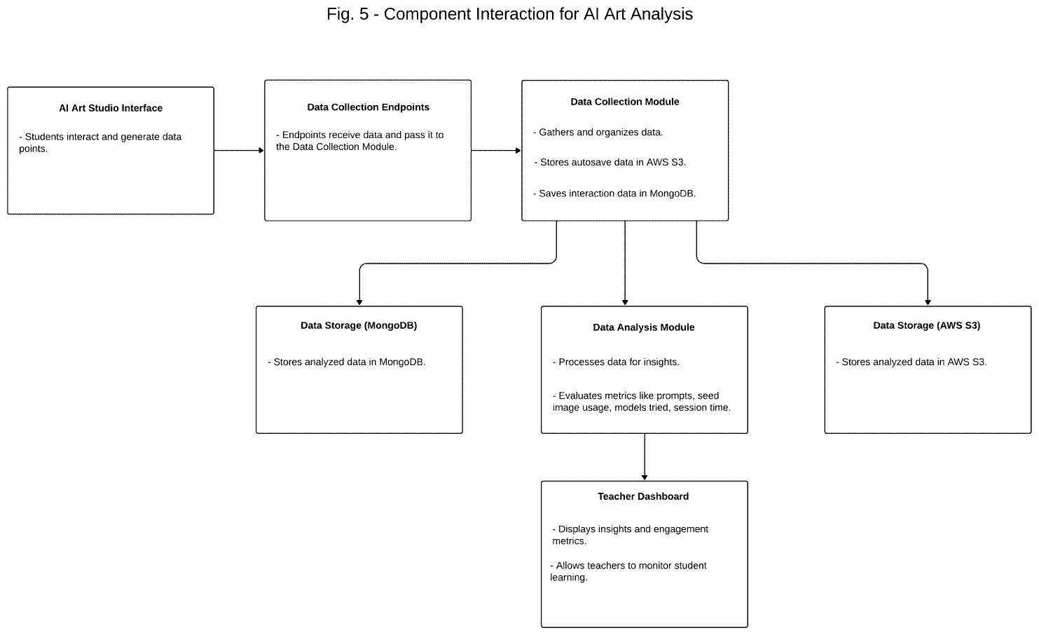

The figure details component interactions for AI Art Analysis, illustrating how data is collected from student interactions, stored in MongoDB, and processed by the Data Analysis Module to generate insights for the Teacher Dashboard.

FIG. 6: Teacher Dashboard UI Flow

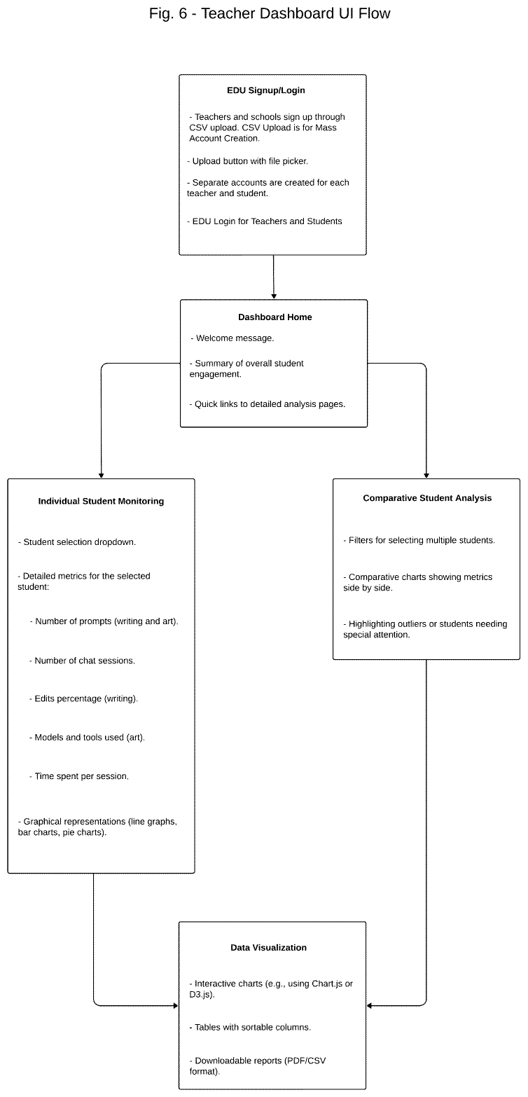

This figure describes the user interface flow of the Teacher Dashboard, starting from CSV upload for account creation to detailed views of student engagement metrics and comparative analyses. Data visualization is enhanced with interactive charts and downloadable reports.

### DETAILED DESCRIPTION

### Teacher Dashboard:

Provides real-time analytics and visualizations of student engagement data.
Facilitates the upload and management of CSV files for large student enrollments.
Includes internal communication tools for teacher collaboration.

### Monitoring AI Interactions:

Tracks human prompts, text edits, and interaction frequency with AI writing and art tools.
Measures the extent of student modifications and customizations.
Analyzes this data to assess student engagement and learning outcomes.

### Analyzing AI Usage Data:

Employs an algorithm to evaluate human prompts and text edits.
Compares AI usage patterns against predefined learning criteria.
Generates alerts and insights for teachers based on engagement levels.

### Generating Personalized Feedback:

Identifies areas for student improvement through interaction data analysis.
Provides tailored suggestions to enhance learning outcomes.
Internal Teacher Communication:
Facilitates collaboration and sharing of insights within the platform.

### Grading Assistance Tool:

Analyzes student responses to provide grading suggestions based on AI engagement.
Ensures grading consistency and efficiency.
High-Level Overview of the Algorithm

### 1. Data Collection:

Collects data from AI Writing and Art Studio interactions.
Tracks prompts, chat sessions, edits percentage, seed image usage, community art models, editing models, and time spent.

### 2. Data Storage:

Stores interaction data in MongoDB.
Saves autosave data in AWS S3.

### 3. Data Analysis:

Processes collected data to evaluate engagement.
Uses statistical methods to analyze interaction frequency and depth.
Compares usage patterns against predefined learning criteria.
Generates insights and alerts based on engagement levels.

### 4. Real-Time Analytics and Visualization:

Displays real-time analytics and historical data on the Teacher Dashboard.
Provides visualizations such as charts and tables.

### 5. Personalized Feedback:

Analyzes interaction data to identify areas for improvement.
Provides tailored suggestions to enhance learning outcomes.

### 6. Grading Assistance:

Uses analyzed data to provide grading suggestions.
Ensures consistency and efficiency in grading based on engagement.

1. A system for monitoring and analyzing student engagement with one or more AI tools, comprising:
a data collection module configured to collect, in real time, student-generated prompts submitted to the AI tools and corresponding AI-generated responses, and to record session metadata including interaction timestamps and an edit percentage representing the proportion of user edits to AI-generated content;
an analytics engine configured to compute a session duration from the interaction timestamps by summing active interaction intervals separated by at least a predefined inactivity threshold, and to calculate engagement metrics based on the session duration, the edit percentage, and prompt frequency, the engagement metrics being indicative of student learning outcomes;
a classification module configured to assign, for each student, an engagement classification based on the calculated engagement metrics for use by educators to assess learning outcomes; and
a teacher dashboard configured to display, for each student, the engagement classification and the associated session details to assist teacher review of student learning.

2. The system of claim 1, wherein the analytics engine further computes an alert condition when engagement metrics indicate potential academic integrity concerns or insufficient engagement for meaningful learning, and the dashboard displays an alert to the teacher.

3. The system of claim 1, further comprising a data storage module storing collected prompts, responses, engagement metrics, and session metadata for historical analysis and review of student learning progress.

4. The system of claim 1, wherein the data collection module supports importing student roster files in CSV format to create accounts and map students to teachers for presentation of engagement and learning information on the teacher dashboard.

5. The system of claim 1, wherein the analytics engine computes an engagement score as a function of prompt count, session duration, and edit percentage, the engagement score being indicative of student learning engagement, and wherein the classification module assigns categories based on thresholds applied to the engagement score.

6. A method implemented by one or more processors for assisting teachers in evaluating student AI use and assessing student learning, the method comprising:
collecting, in real time, student prompts, AI responses, and session metadata including interaction timestamps and an edit percentage;
computing a session duration from the timestamps of interactions by summing active interaction intervals separated by at least a predefined inactivity threshold;
calculating engagement metrics from the session duration, prompt frequency, and edit percentage, the engagement metrics being indicative of student learning outcomes;
classifying each student based on the engagement metrics; and
presenting the classifications and session details to a teacher via a dashboard to assist teacher evaluation of student learning.

7. (canceled)
